(19) United States
(12) Patent Application Publication
(10) Pub. No.: US 2015/0292747 A1
(43) Pub. Date: Oct. 15, 2015

(54) HOME COOKING APPLIANCE HAVING A GAS RAIL SYSTEM

(71) Applicants: BSH HOME APPLIANCES CORPORATION, Irvine, CA (US); BSH BOSCH UND SIEMENS HAUSGERATE GMBH, Munich (DE)

(72) Inventors: Charles Daughtridge, JR., New Bern, NC (US); Tiffany E. Ingersoll, New Bern, NC (US); Benjamin Knight, New Bern, NC (US)

(73) Assignees: BSH HOME APPLIANCES CORPORATION, Irvine, CA (US); BSH BOSCH UND SIEMENS HAUSGERATE GMBH, Munich (DE)

(21) Appl. No.: 14/251,730

(22) Filed: Apr. 14, 2014

(51) Int. Cl. F24C 3/08; B23P 19/00; F24C 15/10

(52) U.S. Cl. CPC F24C 3/085; F24C 15/108; B23P 19/00

(57) ABSTRACT

A home cooking appliance includes a housing and a gas cooktop on the housing. The gas cooktop includes a lower cooktop floor and an upper cooktop surface, the gas cooktop including a cooktop burner on the upper cooktop surface. The gas cooktop includes a gas rail system on the housing and disposed between the lower cooktop floor and the upper cooktop surface. The gas rail system supports functional components of the gas cooktop needed for gas leak testing the gas cooktop. The gas rail system supports the functional components in a spaced manner from the lower cooktop floor.

### FIELD OF THE INVENTION

The present invention is directed to a home cooking appliance having a gas rail system, and more particularly, to a home cooking appliance having a gas rail system supporting functional components of the gas cooktop, which are needed for gas leak testing the gas cooktop, in a spaced manner from the lower cooktop floor and in a manner that does not interference with final assembly tolerances, and a method of assembling a home cooking appliance having a gas rail system supporting functional components of the gas cooktop, which are needed for gas leak testing the gas cooktop, in a spaced manner from the lower cooktop floor and in a manner that does not interference with final assembly tolerances.

### BACKGROUND OF THE INVENTION

A conventional home cooking appliance, such as a slide-in or free-standing gas range, includes a housing having a cooking compartment, such as a baking oven, convection oven, steam oven, warming drawer, etc., and a cooktop formed, for example, by cooking grates disposed over gas burners on top of the housing.

Conventional cooktops commonly are built on the final/main assembly line at the time the components are being assembled with the appliance. As a result, the conventional appliance typically requires a considerable amount of time to leak test after being fully assembled on the final/main assembly line, which can slow the manufacturing process on the final/main assembly line. In the event that the leak testing detects a problem or deficiency in the gas system, the manufacturing process on the final/main assembly line may be slowed or delayed further to provide time to trouble shoot the problems, time to disassemble and repair the components of the gas system for the cooktop burners, and/or time to replace one or more components of the gas system for the cooktop burners.

### SUMMARY OF THE INVENTION

The present invention, as illustrated for example in the exemplary embodiments, is directed to a home cooking appliance comprising a housing, a gas cooktop on the housing, the gas cooktop having a lower cooktop floor and an upper cooktop surface, the gas cooktop having a cooktop burner on the upper cooktop surface, and a gas rail system on the housing, the gas rail system disposed between the lower cooktop floor and the upper cooktop surface, the gas rail system supporting functional components of the gas cooktop needed for gas leak testing the gas cooktop prior to mounting on the housing on the final/main assembly line, wherein the gas rail system supports the functional components in a spaced manner from the lower cooktop floor.

In this way, the present invention can provide a home cooking appliance having a gas rail system that enables leak tests, repairs, or replacements of the functional components of the cooktop to be performed prior to mounting of these components on the appliance on the final/main assembly line by providing a gas rail system having the functional components needed for leak testing (e.g., a fully-functional gas rail system) that is assembled in an assembly area away from the final/main assembly line (i.e., off-line). After leak tests, repairs, and/or replacements of the functional components of the cooktop are performed, the gas rail system enables the functional components to be transported to the final/main assembly line for mounting on the appliance, thereby reducing manufacturing time on the final/main assembly line and reducing manufacturing costs. Additionally, the present invention provides a gas rail system that minimizes or eliminates interference with other components of the appliance, and particularly, interference with tolerances of other components during the assembly process of mounting the gas rail system on the housing of the appliance.

Other features and advantages of the present invention will be described below. To provide a better understanding of the invention, and for further clarification and background of the present invention, various aspects and considerations of a home cooking appliance, which have been recognized by the present invention, first will be explained in greater detail.

As explained above, the cooktop of a conventional home cooking appliance commonly is built on the final/main assembly line at the time the components are being assembled with the appliance. As a result, the conventional appliance typically requires a considerable amount of time to leak test the functional components of the cooktop after being fully assembled on the final/main assembly line, trouble shoot any problems, disassemble and repair the components of the gas system for the cooktop burners, and/or to replace one or more components of the gas system for the cooktop burners, which can slow the manufacturing process on the final/main assembly line and increase manufacturing costs.

The present invention solves these and other problems by minimizing or eliminating the need to perform leak tests, repairs, or replacements of the functional components of the cooktop on the final/main assembly line by providing a gas rail system having the functional components needed for leak testing that can be assembled in an assembly area away from the final/main assembly line (i.e., off-line) and transported to the final/main assembly line for mounting on the appliance, thereby reducing manufacturing time on the final/main assembly line and reducing manufacturing costs. Additionally, the present invention provides a gas rail system that minimizes or eliminates interference with other components of the appliance, and particularly, minimizes or eliminates interference with competing tolerances of other components during the mounting of the gas rail system on the appliance on the final/main assembly line (i.e., in the final stages of the assembly process).

The exemplary gas rail system can include all mechanical and electrical components necessary to perform gas leak testing of the gas rail system prior to being mounted on the appliance on the final/main assembly line, thereby reducing flow time and increasing efficiency on the final/main assembly line, and allowing smaller portions to be set aside or reworked instead of a whole home cooking appliance (e.g., a slide-in range or free-standing range). For example, the mechanical components of the gas rail system can include a gas valve, a valve stem, a burner orifice, and a gas tube connecting the gas valve to the burner orifice for at least one gas burner, and a gas manifold pipe for supplying gas to the gas valve (i.e., to one or more gas valves) and appropriate couplings for connecting the components. The electrical components of the gas rail system can include, for example, a spark module, a control device or valve switch, an igniter, and first wiring connecting the spark module to the control device or valve switch, and second wiring connecting the spark module to the igniter. In this way, the gas rail system can include all mechanical and electrical components, along with any other needed components, that are necessary to perform gas leak tests of the gas rail system prior to the gas rail system being mounted on the appliance on the final/main assembly line. The exemplary gas rail system can include one or more supports rails for supporting the mechanical and electrical components in an assembled state that is capable of being tested for leaks and transported as a subassembly (i.e., unitary unit) to the final/main assembly line.

After the gas rail system is assembled and tested for leaks, the gas rail system is ready to be positioned on a housing of the home cooking appliance. The gas rail system and a component on the housing of the home cooking appliance can include corresponding support features that support the gas rail system on the appliance in a manner in which the gas rail system has a floating relative position with respect to a final assembly position on the appliance. The gas rail system and/or a component on the housing of the home cooking appliance can include, for example, one or more screws, for example, on the manifold pipe, or the like, and/or corresponding bridge lance/tab features to provide an initial position of the gas rail system on the housing. The gas rail system then can be configured to shift or move with respect to the housing as subsequent, or more critical, position parts are assembled, at which time the gas rail system then can be secured in a final assembly position on the housing.

In this way, the exemplary gas rail system allows such labor and time intensive processes of assembling the mechanical and electrical components of the gas burners, as well as leak testing of the gas burners, to be performed away from the final/main assembly line, thereby avoiding an effect on flow time during the assembly process on the final/main assembly line. The gas rail system can be tested early during the assembly, and prior to installation onto the appliance housing on the final/main assembly line. As a result, when the gas rail system is introduced to final/main assembly line, the assembly process is fast, easy, and efficient. Additionally, the gas rail system also absorbs or avoids interference with tolerances of other components so that the technician on the final/main assembly line does not need to fight final component installation. Moreover, the final assembly of the other components and parts of the appliance on the final/main assembly line can be used to complete the mounting and final location/positioning of the gas rail system on the appliance.

The exemplary embodiments provide other advantages. For example, the gas rail system can be assembled prior to the commencement of the manufacturing process of the appliance on the final/main assembly line. Additionally, the gas rail system can be assembled in an assembly area away from the final/main assembly line and prior to the commencement of the manufacturing process of the appliance on the final/main assembly line to help specify the proper size gas leak tester needed such that the manufacturer can procure the correct testing equipment, thereby saving time and expense, and minimizing or avoiding purchases of incorrect testing equipment.

In an exemplary embodiment, the gas rail system can be disposed in a space between the cooktop surface of the appliance and a heat shield or lower inner floor under the outer cooktop surface. The gas rail system can include the functional parts (i.e., mechanical and electrical functional components) for supplying gas (e.g., liquid petroleum gas/liquid propane, or natural gas) to the burners. The gas rail system can be supported above the heat shield (heat shield or lower inner floor of the cooktop) by a predetermined spacing such that the gas rail system has a so-called floating arrangement that avoids hard-stops with respect to a position of the gas rail system, either vertically, horizontally side-to-side, or horizontally front-to-back, thereby minimizing or eliminating an effect on tolerances for final positioning or final assembly. In an exemplary embodiment, the gas rail system can be supported by tabs or the like, which engage one or more support features (e.g., bridge lances) or other components of the appliance. The support features can be formed, for example, on the sidewalls of the appliance or on another surface of the cooktop region of the appliance. The support features can be formed on any suitable location or component, depending on the particular arrangement of the appliance. For example, the support features can be formed on the heat shield or lower inner floor of the cooktop, or on other components of the appliance, such as on an outer surface of a flue of the cooking compartment, a cooling duct of the appliance, etc. One of ordinary skill in the art will recognize that a location of the support features may be based on heat transfer considerations to avoid transferring heat from other components of the appliance to the gas rail system or another component of the appliance.

As explained above, the gas rail system can be a removable sub-assembly that can be configured to incorporate the functional components (e.g., all of the mechanical and/or electrical functional components) necessary for performing leak testing, such as wiring for the jet holder igniters for each burner and connections for gas tubing lines for supplying gas to the orifice of each burner. In an exemplary embodiment, a gas manifold pipe can be supported by one or more rails of the gas rail system and/or the gas rail system can include a mounting assembly for supporting the gas manifold pipe. The gas rail system can include one or more gas valves, valve stems, and control devices or valve switches (such as a potentiometer) that control a flow of gas from the gas manifold pipe into gas tubing supplying the gas to one or more orifices of the gas burners.

The gas rail system can include one or more rails for supporting the mechanical and electrical components. One or more of the rails can include mounting sections for supporting the mechanical and electrical components. One or more of the rails can include one or more support features (e.g., tabs) for engaging one or more corresponding support features (e.g., bridge lance) on the appliance, such as on the sidewalls of the appliance. All of the rails do not need to directly support the gas rail assembly on the appliance. For example, one or more rails may be supported by another rail to support other components of the gas rail system in a floating manner on the appliance.

The gas rail system can include one or more rails that extend over the surface of the heat shield (or lower inner floor of cooktop or other component under the outer cooktop surface) of the appliance in a manner such that the gas rail system is spaced by a predetermined amount of clearance above the heat shield (or lower inner floor of cooktop or other component under the outer cooktop surface) to permit the gas rail system, and all of the components included thereon, to be moved or positioned (e.g., vertically or horizontally) during the final assembly process on the final/main assembly line without limiting a range of motion needed for assembly (e.g., without contacting a hard stop). For example, one or more rails can have a substantially linear arrangement such that the rail extends substantially between the sidewalls of the appliance and over the surface of the heat shield (or lower inner floor of cooktop) of the appliance in a manner such that the gas rail system is spaced by a predetermined amount of clearance above the heat shield to permit the gas rail system. However, in other embodiments, one or more rails can have other shapes and/or elevations above the surface of the heat shield (or lower inner floor of the cooktop or other component under the outer cooktop surface) for supporting the gas rail system in a floating manner while avoiding interference or hard stops with other components of the appliance, or for positioning the components of the gas rail system in a space saving manner, for example, between other components of the appliance without interfering with other components or causing a hard stop with other components. One of ordinary skill in the art will recognize that other arrangements of the gas rail system are possible for supporting the components in a floating manner in a spaced arrangement above the heat shield (or lower inner floor of cooktop or other component under the outer cooktop surface) and other components of the appliance.

In an exemplary embodiment, the components of the gas rail system, such as the one or more rails, can have sufficient rigidity to permit assembly and transporting of the gas rail system from a subassembly area (i.e., a separate, off-line assembly area away from the final/main assembly line) to the final/main assembly line for mounting of the gas rail system onto the appliance. On the other hand, the components of the gas rail system, such as the one or more rails, can be configured to flex by a sufficient amount to permit movement of the gas rail system during final assembly of the gas rail system with the appliance on the final/main assembly line such that the gas rail system can minimize or eliminate any effect on tolerances of other components of the appliance during assembly, such as a position of the cooktop surface during final assembly on the final/main assembly line.

During the manufacturing process, an exemplary embodiment of the gas rail system can be assembled off-line (i.e., away from the assembly line). The gas rail system can include all of the functional components of the cooktop burners necessary to perform gas leak testing. For example, the gas rail system can include all gas tubing, gas valves, valve control devices, valve stems, spark igniter module, igniter wiring, jet holders and orifices, etc. The gas rail system gas leak testing can performed and any problems can be addressed prior to transporting the system to the final/main assembly line. The gas rail system then can be transported to the final/main assembly line for assembly with the appliance.

Once the gas rail system arrives on the final/main assembly line, the gas rail system can be loosely positioned on the appliance, for example by inserting the support features (e.g., tabs) of the gas rail system into (or onto) one or more support features (e.g., bridge lance or the like) of the appliance (e.g., on sidewalls of the appliance), such that the gas rail system is supported in a floating manner spaced above, for example, a surface of the heat shield or lower inner floor of the cooktop housing. The components of the gas rail system can be configured to provide a clearance (e.g., a predetermined clearance distance) from the surface of the heat shield or another surface, thereby preventing a hard stop against the heat shield or another surface, which may affect final positioning of the gas rail system, cooktop, etc.

The size and shape of each of the support features (e.g., tab, projection, etc.) of the gas rail system and the support features (e.g., bridge lance, slot, etc.) of the appliance can be configured to permit each tab to be supported, while also providing additional clearance such that each tab is free to move, at least to a limited extent, in one or more directions with respect to the corresponding support feature of the appliance. The tabs also are configured to have a size and shape that permits the tabs to move vertically and/or horizontally with respect to the corresponding support features of the appliance. The tabs and the corresponding support features are not limited to any particular size and shape, and can be any suitable size or shape that permits the tabs to be passed through or engage with the corresponding support features. In other embodiments, the tabs need not pass through the corresponding support features, or similar features, so long as at least a portion of the corresponding components engage each other to loosely fix or restrict a range of motion of the gas rail system such that the gas rail system is approximately positioned for final assembly but also is capable of moving in one or more directions to accommodate tolerances of other components during final assembly.

After the gas rail system is loosely positioned on the appliance, the outer surface of the cooktop can be mounted on the appliance and one or more screws (or other securing means, not shown) can be inserted, for example, through the outer surface of the cooktop and into the orifices of each burner. As the screws are tightened, the gas rail system can be configured to be drawn into a final assembled position owing to the permissible movement of the tabs in the corresponding support features, as well as to the elimination or minimizing of the gas rail system contacting other components of the appliance (i.e., minimizing or eliminating hard stops). As a result, the location of other components, such as the location of the outer surface of the cooktop, can be precisely located without interference from the gas rail system.

When the gas rail system is in the final assembly position, the gas rail system can continue to be supported in a floating manner spaced above a surface of the heat shield (or lower inner floor of cooktop or other component).

In other exemplary embodiments, the gas rail system can be supported in a spaced manner above the surface of the heat shield (or lower inner floor of cooktop) and other components of the appliance by other means. For example, one or more support features (e.g., tabs) can be formed on one or more rails of the gas rail system for supporting the gas rail system in a spaced manner above the surface of the heat shield (or lower inner floor of cooktop or another surface) and other components of the appliance. In another example, the support features (e.g., tabs) can be formed only on a first rail, a second rail, a center rail, or the spark module rail section, or on one or more of the first rail, the second rail, the center rail, and the spark module rail section. In other exemplary embodiments, the tabs can be formed on other components of the gas rail system.

In other embodiments, the gas rail system can be supported by/from another component of the appliance such that the gas rail system is arranged in a spaced manner above the surface of the heat shield (or lower inner floor of cooktop) and other components of the appliance without departing from the spirit and scope of the present invention. For example, the gas rail system can be supported by/from a support bracket for another component of the appliance, such as a support bracket for the control panel. In another example, the gas rail system can be supported by/from a surface of the flues or related flue ducts, cooling air ducts, exhaust ducts, etc., or from another heat shield for thermally isolating the gas rail system from these components.

For purposes of this invention, the heat shield or lower inner floor of the cooktop can include a surface disposed between an oven cooking chamber and the outer cooktop surface.

The features of the present invention can be provided separately, or in combination with each other or in combination with other features of a home cooking appliance for minimizing or eliminating an effect on tolerances during the final assembly of the appliance.

The features of the present invention are not limited to any particular type of cooking appliance or to a cooking appliance having any particular arrangement of features. For example, one of ordinary skill in the art will recognize that the features of the present invention are not limited to a slide-in gas cooking appliance, and can include, for example, a built-in cooking appliance such as a gas range, a cook top, or another cooking appliance that will benefit from a gas rail system that enables leak tests, repairs, or replacements of the functional components of the cooktop to be performed prior to mounting of these components on the appliance, and/or that minimizes or eliminates interference with other components of the appliance, and particularly, interference with tolerances of other components during the assembly process of mounting the gas rail system on the housing of the appliance.

Other features and advantages of the present invention will become apparent to those skilled in the art upon review of the following detailed description and drawings.

### BRIEF DESCRIPTION OF THE DRAWINGS

These and other aspects and features of embodiments of the present invention will be better understood after a reading of the following detailed description, together with the attached drawings, wherein:

FIG. 1 is a perspective view of a home cooking appliance according to an exemplary embodiment of the invention;

FIG. 2A is a cut-away perspective view of a home cooking appliance according to an exemplary embodiment of the invention;

FIG. 2B is another cut-away perspective view of the home cooking appliance according to an exemplary embodiment of the invention in FIG. 2A;

FIG. 2C is another cut-away perspective view of a home cooking appliance according to an exemplary embodiment of the invention in FIG. 2A;

FIG. 3A is a perspective view of a gas rail system according to an exemplary embodiment of the invention;

FIG. 3B is a top view of a gas rail system according to the exemplary embodiment of FIG. 3A;

FIG. 3C is a side view of a gas rail system according to the exemplary embodiment of FIG. 3A; FIG. 3D is another top view of the gas rail system of FIG. 3B including electrical wiring;

FIG. 4A is a perspective view of a gas rail system according to an exemplary embodiment of the invention;

FIG. 4B is a top view of a gas rail system according to the exemplary embodiment of FIG. 4A;

FIG. 4C is a side view of a gas rail system according to the exemplary embodiment of FIG. 4A;

FIG. 4D is another top view of the gas rail system of FIG. 4B including electrical wiring;

FIG. 5A is a schematic, partial cross-sectional view of a gas rail system on a home cooking appliance according to the exemplary embodiment during assembly;

FIG. 5B is a schematic, partial cross-sectional view of the gas rail system on the home cooking appliance according to the exemplary embodiment of FIG. 5A in an assembled state;

FIG. 5C is a partial, side view of the gas rail system on the home cooking appliance according to the exemplary embodiment of FIG. 5A during assembly; and

FIG. 5D is a partial, side view of a gas rail system on a home cooking appliance according to an alternative exemplary embodiment during assembly.

### DETAILED DESCRIPTION OF THE EXEMPLARY EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

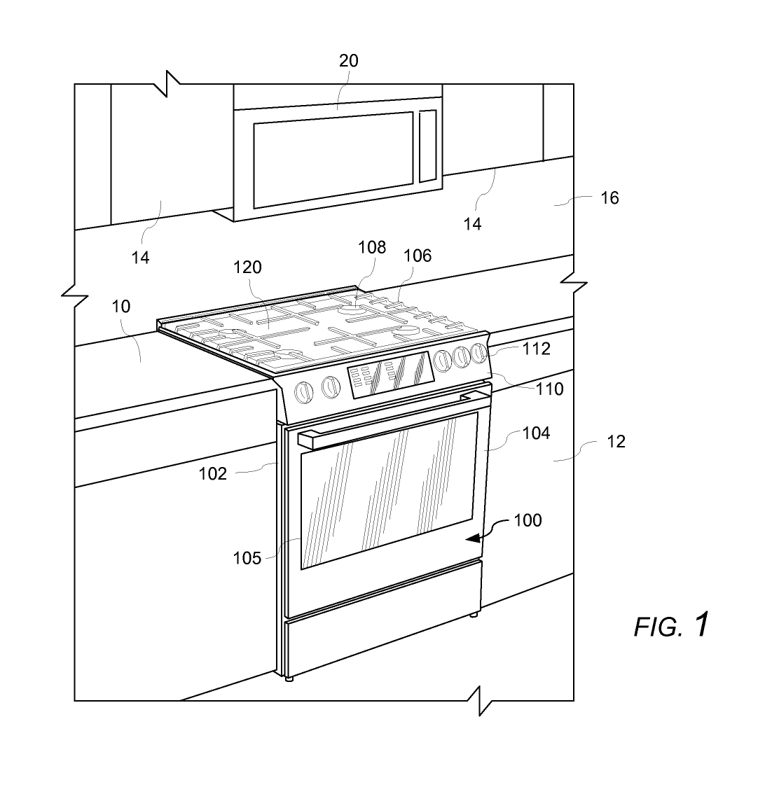

Referring now to the drawings, FIGS. 1-5D illustrate exemplary embodiments of a home cooking appliance having a gas rail system.

With reference again to FIG. 1, an exemplary embodiment of a home cooking appliance 100, such as a slide-in range or free-standing range, will now be described. The home cooking appliance 100 has a housing 102, for example, with a cooking compartment, such as a baking oven, convection oven, steam oven, warming drawer, etc., in the housing 102 and accessible through a door 104 in a front of the housing 102. The door 104 has a door glass 105. The home cooking appliance 100 has a cooktop surface 120 (e.g., a cooktop drip tray) on a top of the housing 102. The cooktop surface 120 includes one or more gas burners 108. The cooktop 102 can include one or more cooking grates 106 having an upper surface for supporting cookware over the burners 108. The appliance 100 can include a control panel 110 having a plurality of control knobs 112 for controlling the operation of the burners 108 and the cooking compartment. As shown in FIG. 1, a home cooking appliance 100 can be disposed between floor cabinets 12 and counters 10 of a kitchen. An over-the-range (OTR) microwave oven or convection microwave oven 20 can be disposed over the cooking surface 106 of the home cooking appliance 100. The home cooking appliance 100 according to the invention is not limited to any particular type of cooking appliance or to a cooking appliance having any particular arrangement of features. For example, one of ordinary skill in the art will recognize that the features of the present invention are not limited to a slide-in range or free-standing range or gas cooking appliance, and can include, for example, other types of cooking appliances such as a cook top, a built-in cooktop, or another cooking appliance that will benefit from the advantages of the gas rail system according to the exemplary embodiments of the invention.

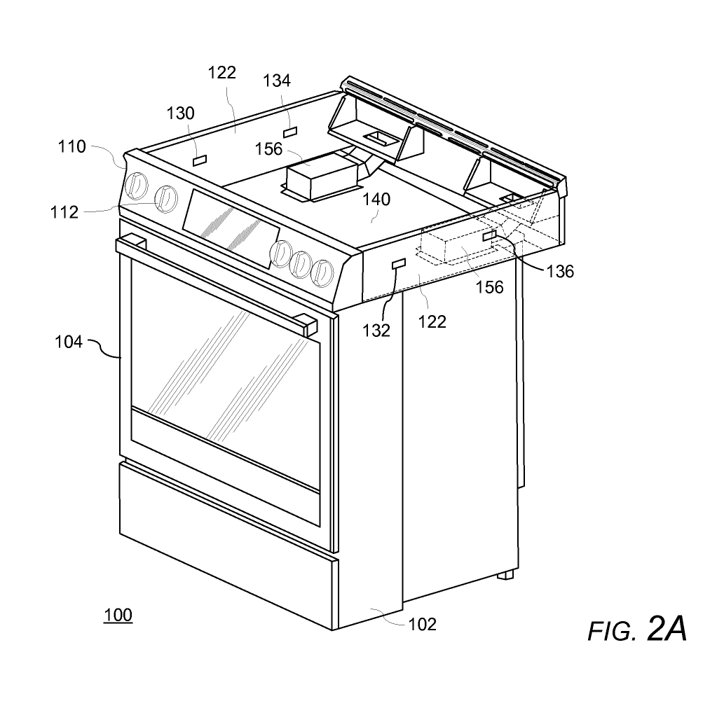

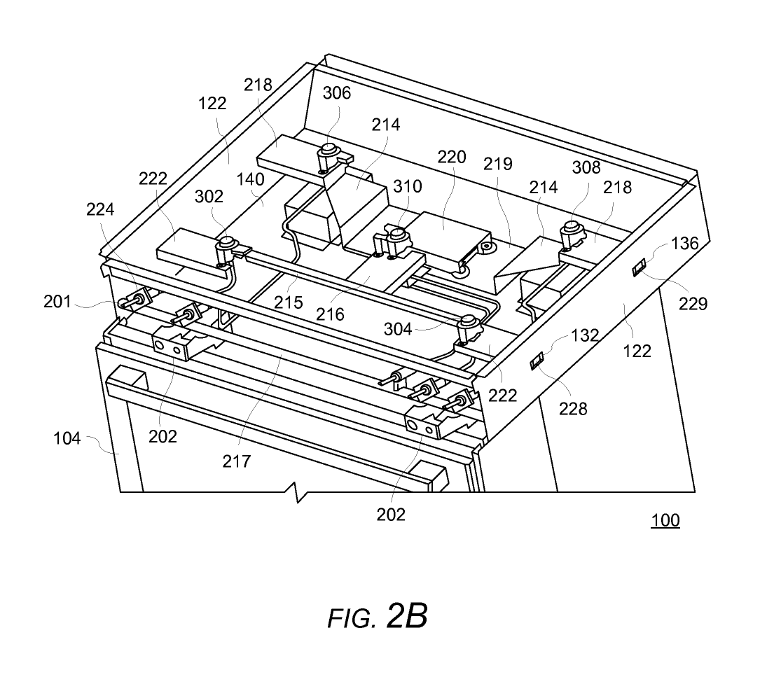

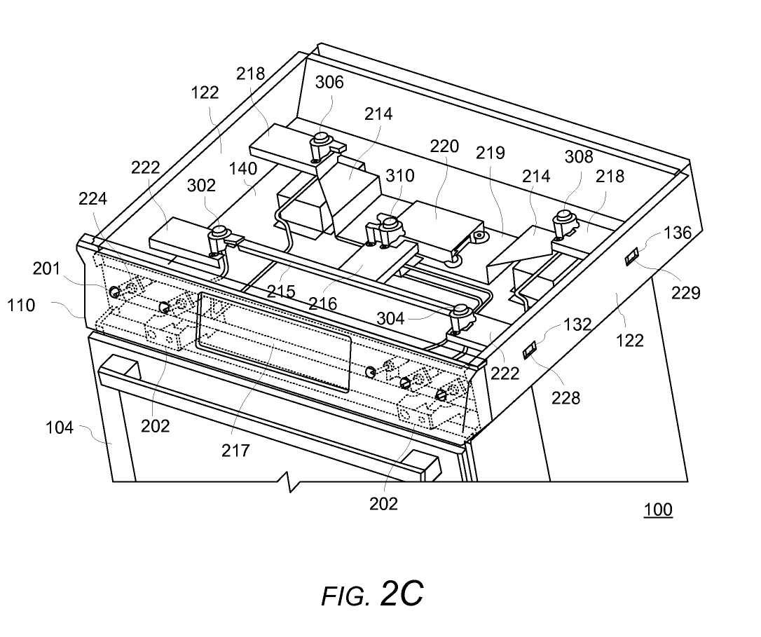

With reference to FIGS. 2A-2C, an exemplary embodiment of a home cooking appliance 100 having a gas rail system 200 will now be described.

In FIG. 2A, the cooktop surface 120, the cooking grates 106, the burners 108, and the gas rail system 120 have been omitted to show the components that are otherwise concealed from view in an assembled state. Particularly, the home cooking appliance 100 includes a heat shield (or lower floor of cooktop) 140 disposed between the cooking compartment and the outer cooktop surface 120. The cooking compartment can include one or more flues 156 for exhausting combustion gases from the cooking compartment. The housing 102 can include sidewalls 122 for supporting the cooktop surface 120 (not shown in FIG. 2A) on the appliance 100. As shown in FIG. 2A, the sidewalls 122 can include one or more support features 130, 132, 134, 136 (e.g., bridge lance, opening, slot, tab, flange, etc.) for supporting the gas rail system 200 (not shown in FIG. 2A). In other embodiments, the support features can be formed on other components of the appliance.

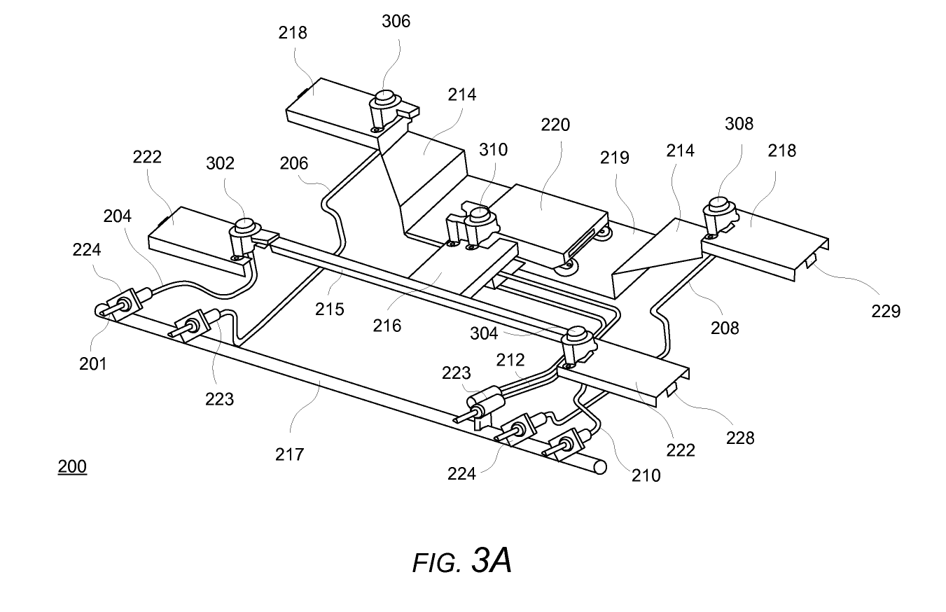

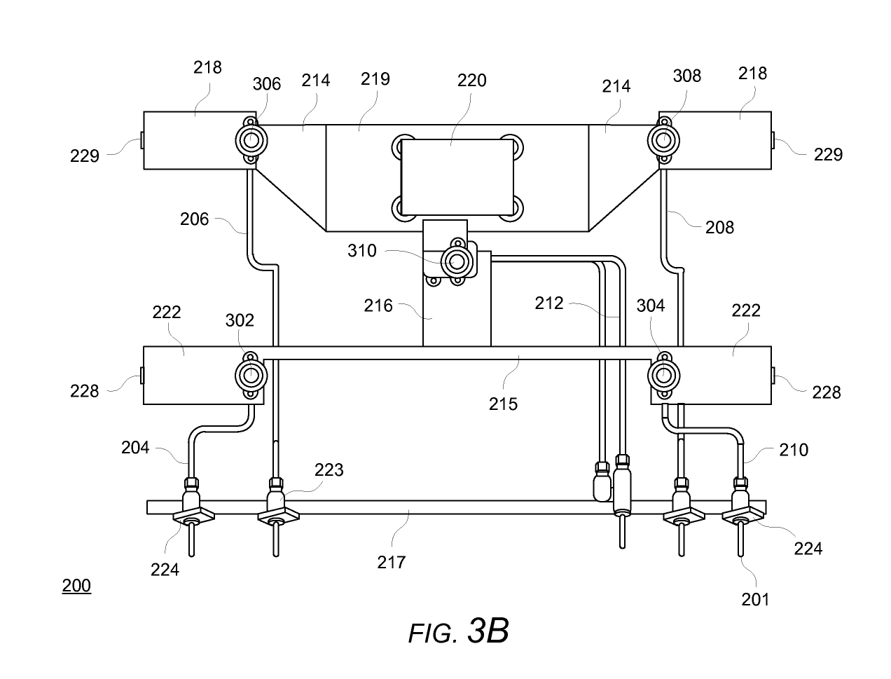

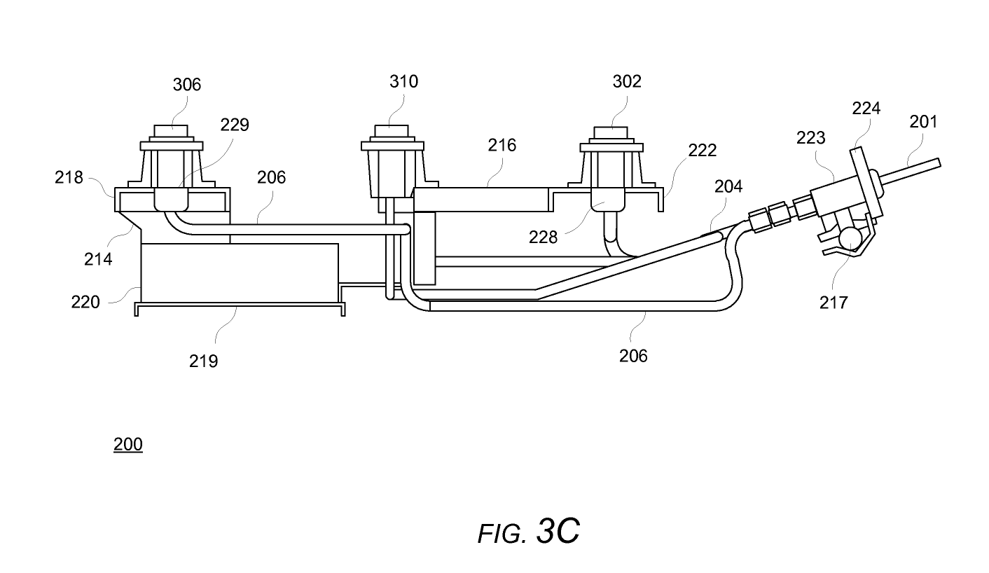

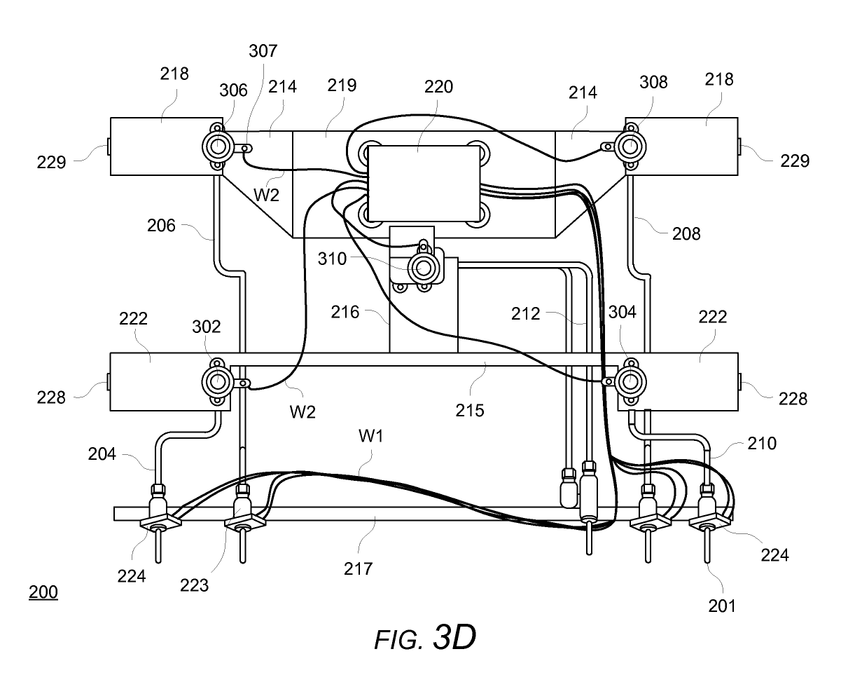

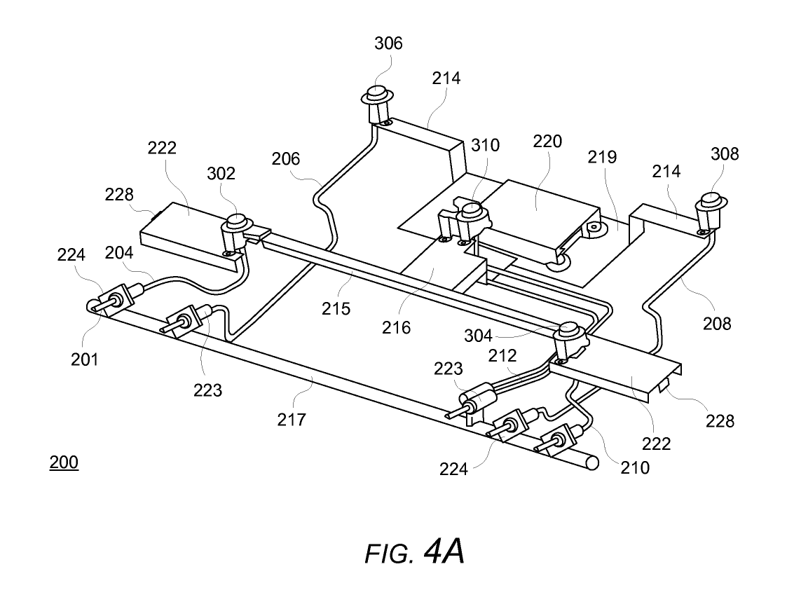

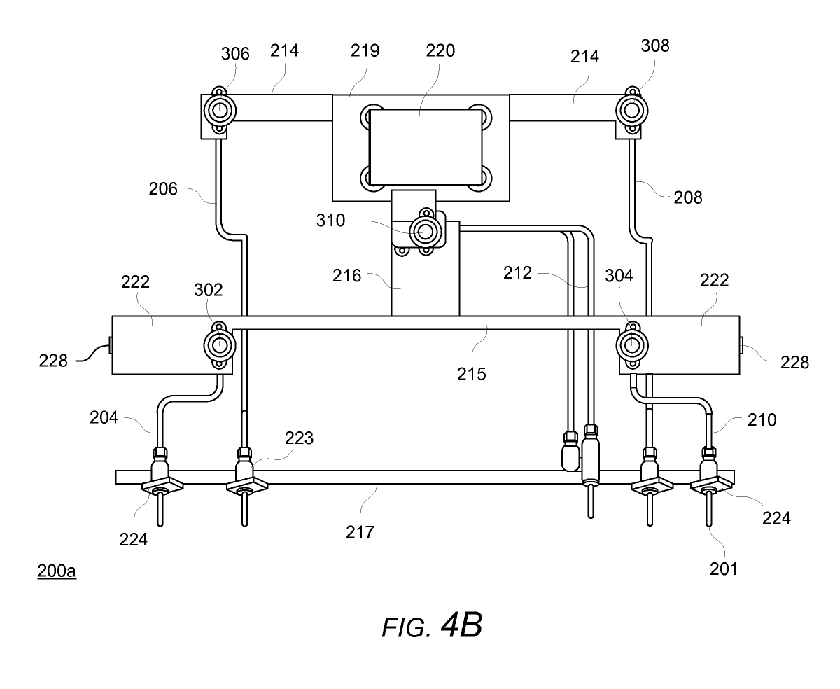

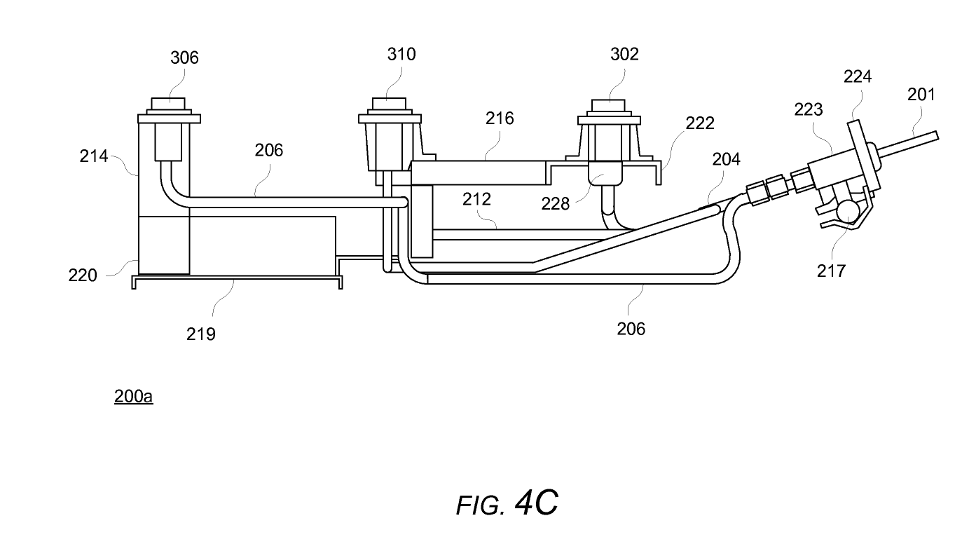

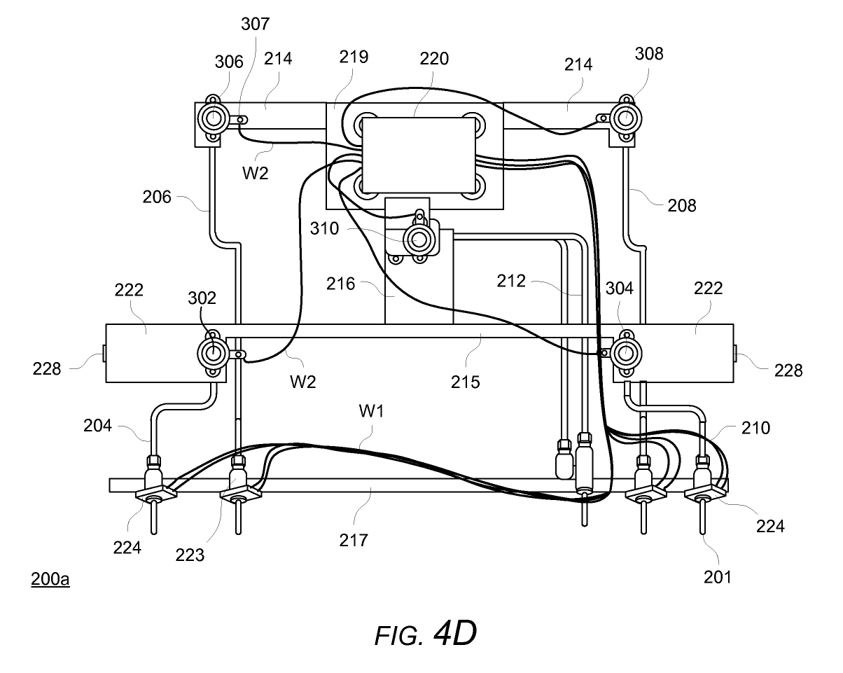

With reference to FIGS. 2B and 2C, FIGS. 3A-3D and 4A-4D, exemplary embodiments of a gas rail system 200, and a gas rail system 200 assembled with a home cooking appliance 100, will now be described. FIGS. 2B and 2C show an example of a gas rail system 200 positioned on a home cooking appliance, and FIGS. 3A-3D and 4A-4D illustrate the features of the gas rail system 200 in a removed state from the appliance 100. For clarity, the wiring has been omitted from FIGS. 2A-2C, 3A-3C, and 4A-4C.

As shown in FIGS. 2B and 2C, a gas rail system 200 can be disposed in a space between the heat shield 140 and a cooktop surface 120 (shown in FIG. 1, not shown in FIGS. 2B and 2C). The gas rail system can include the functional parts (e.g., mechanical and electrical functional parts or components) for supplying gas (e.g., liquid petroleum gas/liquid propane, or natural gas) to the burners (e.g., 108, not shown in FIGS. 2B and 2C). The features of the gas rail system 200 are identified by reference numerals in FIGS. 2B and 2C; however, these features will be described in greater detail with reference to FIGS. 3A-3D and 4A-4D below.

As shown in FIGS. 2B and 2C, the gas rail system 200 can be supported above the heat shield 140 by a predetermined spacing such that the gas rail system 200 has a so-called floating arrangement that avoids hard-stops with respect to a position of the gas rail system 200, either vertically, horizontally side-to-side, or horizontally front-to-back, thereby minimizing or eliminating an effect on tolerances for final positioning or final assembly. In the exemplary embodiment illustrated in FIGS. 2B and 2C, the gas rail system 200 is supported by one or more support features, such as tabs 228, 229 or the like, which engage one or more corresponding support features 130, 132, 134, 136 (e.g., bridge lance, opening, slot, flange, etc.) on the appliance, such as on the sidewalls 122 of the appliance. The features, operation, and assembly of the gas rail system 200, the support features 228, 229 (e.g., tabs), and corresponding support features 130, 132, 134, 136 (e.g., bridge lance, opening, slot, tab, flange, etc.) of the appliance (e.g., of the sidewalls 122) will be described below.

With reference to FIGS. 3A-3D, an exemplary embodiment of a gas rail system 200 in a removed state from the appliance 100, will now be described. For clarity, the wiring has been omitted from FIGS. 3A-3C.

As shown in FIGS. 3A-3D, the gas rail system 200 can be a removable sub-assembly that can be configured to incorporate the functional components necessary for leak testing, such as wiring for the jet holder igniters for each burner and connections for gas tubing lines for supplying gas to the orifice of each burner. For example, the gas rail system 200 can include a mounting assembly 202 for supporting a gas manifold pipe 217. The gas rail system 200 can include one or more gas valves 223, valve stems 201, and control devices or valve switches 224, such as a potentiometer, that control a flow of gas from the gas manifold pipe 217 into gas tubing 204, 206, 208, 210, 212, which supply the gas to one or more orifices 302, 304, 306, 308, 310 of the gas burners. As shown in FIGS. 3A-3D, the gas rail system 200 includes tubing 204 for supplying gas to the left front orifice 302, tubing 206 for supplying gas to the left rear orifice 306, tubing 208 for supplying gas to the right rear orifice 308, tubing 210 for supplying gas to the right front orifice 304, and tubing 212 for supplying gas to the center orifice 310. One of ordinary skill in the art will recognize that other arrangements are possible.

With reference again to FIGS. 3A-3D, the gas rail system 200 includes a first rail 215 for supporting the left front orifice 302 and the right front orifice 304. The first rail 215 includes mounting sections 222 for supporting the orifice 302, 304 (e.g., included in the jet holders). The mounting sections 222 include one or more support features 228 (e.g., tabs) for engaging the corresponding support features 130, 132 (e.g., bridge lance, opening, slot, flange, etc.) on the appliance. In this example, the corresponding support features 130, 132 are formed on the sidewalls 122 of the appliance 100 (as shown in FIGS. 2A-2C). However, in other embodiments, the corresponding support features 130, 132 can be formed on other components of the appliance.

The exemplary gas rail system 200, shown in FIGS. 3A-3D, includes a second rail 214 for supporting the left rear orifice 306 and the right rear orifice 308. The second rail 214 includes mounting sections 218 for supporting the orifice 306, 308 (e.g., included in the jet holders). The mounting sections 218 include one or more tabs 229 for engaging the corresponding support features 134, 136 (e.g., bridge lance, opening, slot, flange, etc.) in the sidewalls 122 of the appliance 100 (as shown in FIGS. 2A-2C). The second rail 214 includes another rail section 219 that supports a spark module 220, which can be electrically coupled to the igniters of each of the burners. For example, FIG. 3D illustrates wiring W2 electrically connecting an igniter 307 of each burner to the spark module 220.

The exemplary gas rail system 200, shown in FIGS. 3A-3D, includes a center rail 216 for supporting the center orifice 310. Rather than engaging the sidewalls 122 of the appliance 100, the center rail 216 can be configured to extend between and be supported at each end by a portion of the first rail 215 and the second rail 214.

As shown in FIGS. 3A-3D, the first rail 215 can have a substantially linear arrangement such that the first rail 215 can extend between the sidewalls 122 and over the surface of the heat shield 140 of the appliance 100 in a manner such that the gas rail system 200 is spaced by a predetermined amount of clearance above the heat shield 140 to permit the gas rail system 200, and all of the components included thereon, to be moved or positioned during the final assembly without limiting a range of motion needed for assembly (e.g., without contacting a hard stop). However, in other embodiments, the first rail 215 can have other shapes and/or elevations above the heat shield 140, for example, for avoiding interference or hard stops with other components of the appliance 100. For example, as shown in the exemplary embodiments of FIGS. 3A-3D, the second rail 214 has angled sections coupling the mounting sections 218 to the spark module rail section 219. In this way, the spark module 220 can be supported in a floating manner between the flues 156 (shown in FIGS. 2A-2C) that saves space without interfering with the flues 156 and without causing a hard stop with the flues 156, the heat shield 140, or other components of the appliance 100. One of ordinary skill in the art will recognize that other arrangements of the gas rail system 200 are possible for supporting the components in a floating manner in a spaced arrangement above the heat shield 140 and other components of the appliance 100.

FIG. 3D illustrates the gas rail system 200 including electrical wiring W1 connecting each of the control devices or valve switches 224 to the spark module 220, and electrical wiring W2 connecting the spark module 220 to each of the igniters 307 of the one or more orifices 302, 304, 306, 308, 310 of the gas burners. The functional components of the gas rail system 200 can be secured to the rails (e.g., 214, 215, 216, and/or 219) using connection means, such as one or more screws or other suitable fasteners or connectors. The rails (e.g., 214, 215, 216, and/or 219) can be coupled together or integrally formed.

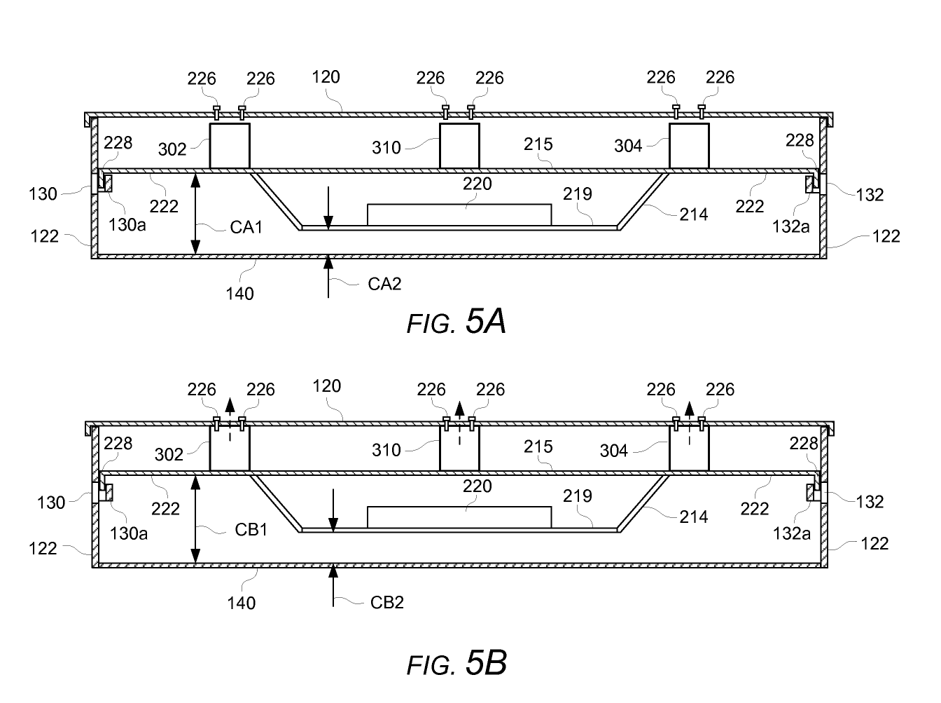

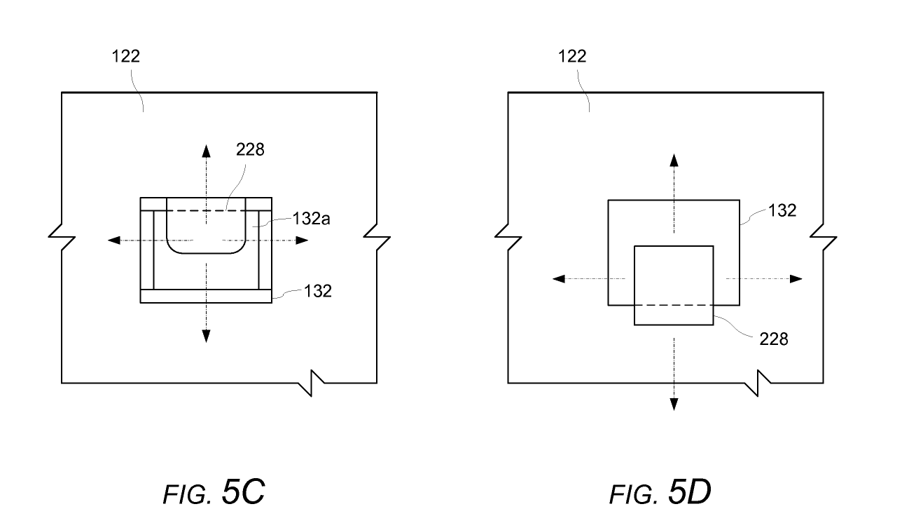

With reference again to FIGS. 3A-3D, the components of the gas rail system 200, such as the first rail 215, second rail 214 (and rail section 219), and center rail 216, can have sufficient rigidity to permit assembly and transporting of the gas rail system 200 from a separate, assembly area (i.e., off-line assembly area away from the final/main assembly line) to the final/main assembly line for mounting of the gas rail system 200 onto the appliance 100. On the other hand, the components of the gas rail system 200, such as the first rail 215, second rail 214 (and rail section 219), and center rail 216, can be configured to flex by a sufficient amount, or move with respect to each other by a sufficient amount, to permit movement of the gas rail system 200 during final assembly of the gas rail system 200 with the appliance 100 such that the gas rail system 200 can minimize or eliminate any effect on tolerances of other components of the appliance 100 during assembly, such as a position of the cooktop surface 120 during final assembly. These features will be described in greater detail below with reference to FIGS. 5A-5D.

With reference to FIGS. 4A-4D, another exemplary embodiment of a gas rail system 200a in a removed state from the appliance 100, will now be described. For clarity, the wiring has been omitted from FIGS. 3A-3C.

Similar to the example in FIGS. 3A-3D, the gas rail system 200a illustrated in FIGS. 4A-4D can be a removable sub-assembly that can be configured to incorporate the functional components necessary for leak testing, such as wiring for the jet holder igniters for each burner and connections for gas tubing lines for supplying gas to the orifice of each burner. For example, the gas rail system 200a can include a mounting assembly 202 for supporting a gas manifold pipe 217. The gas rail system 200a can include one or more gas valves 223, valve stems 201, and control devices or valve switches 224, such as a potentiometer, that control a flow of gas from the gas manifold pipe 217 into gas tubing 204, 206, 208, 210, 212, which supplies gas to one or more orifices 302, 304, 306, 308, 310 of the gas burners. As shown in FIGS. 4A-4D, the gas rail system 200a includes tubing 204 for supplying gas to the left front orifice 302, tubing 206 for supplying gas to the left rear orifice 306, tubing 208 for supplying gas to the right rear orifice 308, tubing 210 for supplying gas to the right front orifice 304, and tubing 212 for supplying gas to the center orifice 310. One of ordinary skill in the art will recognize that other arrangements are possible.

As shown in FIGS. 4A-4D, the gas rail system 200a includes a first rail 215 for supporting the left front orifice 302 and the right front orifice 304. The first rail 215 includes mounting sections 222 for supporting the orifice 302, 304 (e.g., included in the jet holders). The mounting sections 222 include one or more support features 228 (e.g., tabs) for engaging the corresponding support features 130, 132 (e.g., bridge lance, opening, slot, flange, etc.) on the appliance. In this example, the corresponding support features 130, 132 are formed in the sidewalls 122 of the appliance 100 (as shown in FIGS. 2A-2C). However, in other embodiments, the corresponding support features 130, 132 can be formed on other components of the appliance.

The exemplary gas rail system 200a, shown in FIGS. 4A-4D, includes a second rail 214 for supporting the left rear orifice 306 and the right rear orifice 308, and a center rail 216 for supporting the center orifice 310. Rather than engaging the sidewalls 122 of the appliance 100, the second rail 214 and the center rail 216 can be configured to be supported in a floating manner from the first rail 215 (e.g., supported only by the first rail 215). The first rail 215 can be configured to have sufficient structural rigidity to support the center rail 216, spark module rail section 219, and the second rail 214, etc. in a spaced manner above the surface of the heat shield 140 and other components of the appliance 100 using, for example, the tabs 228 of the mounting sections 222. In this example, the second rail 214 supports the left rear orifice 306, the right rear orifice 308, and the corresponding tubing 206, 208 without engaging the sidewalls 122 or other components of the appliance 100. The second rail 214 can be configured to flex or move by a sufficient amount to permit movement of the left rear orifice 306, the right rear orifice 308, and/or the corresponding tubing 206, 208 during final assembly of the gas rail system 200a with the appliance 100, thereby minimizing or eliminating any effect on tolerances of other components of the appliance 100 during assembly, such as a position of the cooktop surface 120 during final assembly.

As shown in FIGS. 4A-4D, the first rail 215 can have a substantially linear arrangement such that the first rail 215 can extend between the sidewalls 122 and over the surface of the heat shield 140 of the appliance 100 in a manner such that the gas rail system 200a is spaced by a predetermined amount above the heat shield 140 to permit the gas rail system 200a, and all of the components included thereon, to be moved or positioned during the final assembly without limiting a range of motion needed for assembly (e.g., without contacting a hard stop). However, in other embodiments, the first rail 215 can have other shapes and/or elevations above the heat shield 140, for example, for avoiding interference or hard stops with other components of the appliance 100. For example, as shown in the exemplary embodiments of FIGS. 4A-4D, the second rail 214 has angled sections coupling the mounting sections 218 to the spark module rail section 219. In this way, the spark module 220 can be supported in a floating manner between the flues 156 (shown in FIGS. 2A-2C) that saves space without interfering with the flues 156 and without causing a hard stop with the flues 156, the heat shield 140, or other components of the appliance 100. One of ordinary skill in the art will recognize that other arrangements of the gas rail system 200a are possible for supporting the components in a floating manner in a spaced arrangement above the heat shield 140 and other components of the appliance 100.

FIG. 4D illustrates the gas rail system 200a including electrical wiring W1 connecting each of the control devices or valve switches 224 to the spark module 220, and electrical wiring W2 connecting the spark module 220 to each of the igniters 307 of the one or more orifices 302, 304, 306, 308, 310 of the gas burners. The components of the gas rail system 200 can be secured to the rails (e.g., 214, 215, 216, and/or 219) using connection means, such as one or more screws or other suitable fasteners or connectors. The rails (e.g., 214, 215, 216, and/or 219) can be coupled together or integrally formed.

With reference again to FIGS. 4A-4D, the components of the gas rail system 200a, such as the first rail 215, second rail 214 (and rail section 219), and center rail 216, can have sufficient rigidity to permit assembly and transporting of the gas rail system 200a from a separate, assembly area (i.e., off-line assembly area away from the final/main assembly line) to the final/main assembly line for mounting of the gas rail system 200a onto the appliance 100. On the other hand, the components of the gas rail system 200a, such as the first rail 215, second rail 214 (and rail section 219), and center rail 216, can be configured to flex by a sufficient amount to permit movement of the gas rail system 200a during final assembly of the gas rail system 200a with the appliance 100 such that the gas rail system 200a can minimize or eliminate any effect on tolerances of other components of the appliance 100 during assembly, such as a position of the cooktop surface 120 during final assembly on the final/main assembly line.

With reference to FIGS. 5A-5D, an example showing the assembly of a gas rail system 200, 200a on an appliance 100, will now be described.

FIG. 5A schematically illustrates an exemplary embodiment of a gas rail system 200, 200a in a loosely mounted position on the appliance, while FIG. 5B schematically illustrates an exemplary embodiment of a gas rail system 200, 200a in a final assembled position with the cooktop surface 120. During the manufacturing process, the gas rail system 200, 200a can be assembled in a separate assembly area (i.e., off-line away from the final/main assembly line). The gas rail system 200, 200a can include all of the functional components (i.e., functional mechanical and electrical components) of the cooktop burners necessary to perform gas leak testing. For example, the gas rail system 200, 200a can include all gas tubing (e.g., 204, 206, 208, 210, 212 in FIGS. 3A-4D), gas valves (e.g., 223 in FIGS. 3A-4D), valve control devices (e.g., 224 in FIGS. 3A-4D), valve stems (e.g., 201 in FIGS. 3A-4D), spark igniter module (e.g., 220 in FIGS. 3A-4D), igniter wiring (e.g., W1, W2 in FIGS. 3D and 4D), jet holders and orifices (e.g., 302, 304, 306, 308, 310 in FIGS. 3A-4D). After the subassembly is completed in the separate assembly area, gas leak testing can performed on the components of the gas rail system 200, 200a and any problems can be addressed prior to transporting the system 200, 200a to the final/main assembly line. The gas rail system 200, 200a then can be transported to the final/main assembly line for mounting on the appliance 100.

After the gas rail system 200, 200a has been tested and transported to the final/main assembly line, the support features (tabs 128 and/or tabs 129, not shown in FIGS. 5A and 5B) of the gas rail system 200, 200a can be inserted into the corresponding support features 130, 132 (and/or 134, 136) (e.g., bridge lance, opening, slot, flange, etc.) of the appliance (e.g., of the sidewalls 122 of the appliance), as shown in FIG. 5A, such that the gas rail system 200, 200a is supported in a floating manner spaced above a surface of the heat shield 140 (lower inner floor of the cooktop). For example, the components of the gas rail system 200, 200a can have a clearance CA1, CA2 from the surface of the heat shield 140, thereby preventing a hard stop against the heat shield 140, which may affect final positioning of the gas rail system 200, 200a, cooktop 120, etc.

With reference again to FIGS. 5A-5C, after the gas rail system 200, 200a has been tested, the gas rail system 200, 200a according to an exemplary embodiment can be supported on the appliance by a support features (e.g., tab 128) that engages a corresponding support feature 130, such as a bridge lance 130a, formed on the appliance (e.g., in the sidewall 122 of the appliance). The size and shape of the tab 128 of the gas rail system 200, 200a and the bridge lance 130, 130a, 132, 132a can be configured such that the tab 128 is free to move, at least to a limited extent, in one or more directions with respect to the bridge lance 130, 130a, 132, 132a. For example, in the illustrated example, the tab 128 of the gas rail system 200, 200a can be configured to have a size and shape that permits the tab 128 to move vertically and/or horizontally with respect to the bridge lance 130, 130a, 132, 132a, as shown by the arrows in FIG. 5C. The tab 128 and bridge lance 130, 130a, 132, 132a are not limited to any particular size and shape, and can be any suitable size or shape that permits the tab 128 to engage with the bridge lance 130, 130a, 132, 132a such that at least a portion of the corresponding components engage each other to loosely fix or restrict a range of motion of the gas rail system 200, 200a such that the gas rail system 200, 200a is approximately positioned for final assembly but also is capable of moving in one or more directions to accommodate tolerances of other components during final assembly.

With reference to FIG. 5D, another exemplary embodiment of a corresponding support feature 130, 132 on the appliance, will now be described. In this example, the size and shape of the support feature (e.g., tab 128) of the gas rail system 200, 200a and the corresponding support feature 130, 132 (e.g., opening, slot, etc.) can be configured to permit the tab 128 to pass through the opening 130, 132, while also providing additional clearance such that the tab 128 is free to move, at least to a limited extent, in one or more directions with respect to the opening 130, 132. For example, in the illustrated example, the tab 128 of the gas rail system 200, 200a is configured to have a size and shape that permits the tab 128 to pass freely through the opening 130, 132. The tab 128 also is configured to have a size and shape that permits the tab 128 to move vertically and/or horizontally with respect to the opening 130, 132, as shown by the arrows in FIG. 5D. The tab 128 and the opening 130, 132 are not limited to any particular size and shape, and can be any suitable size or shape that permits the tab 128 to be passed through or engage with the opening 130, 132. In other embodiments, the tab 128 does not need to pass through the opening 130, or similar feature, so long as at least a portion of the corresponding components engage each other to loosely fix or restrict a range of motion of the gas rail system 200, 200a such that the gas rail system 200, 200a is approximately positioned for final assembly but also is capable of moving in one or more directions to accommodate tolerances of other components during final assembly.

With reference again to FIG. 5B, after the gas rail system 200, 200a is loosely positioned on the appliance 100, one or more screws 226 (or other securing means, not shown) are inserted, for example, through the surface of the cooktop 120 and into the orifices 302, 304. As the screws 226 are tightened, the gas rail system 200, 200a can be drawn into a final assembled position, as shown in FIG. 5B, owing to the permissible movement of the tabs 128 in the slots 130, 132, as well as to the elimination or minimizing of the gas rail system 200, 200a contacting other components of the appliance 100 (i.e., minimizing or eliminating hard stops). As a result, the location of other components, such as the location of the cooktop 120, can be precisely located without interference from the gas rail system 200, 200a.

As shown in FIG. 5B, when the gas rail system 200, 200a is in the final assembly position, the gas rail system 200, 200a can continue to be supported in a floating manner spaced above a surface of the heat shield 140. For example, the components of the gas rail system 200, 200a can have a clearance CB1, CB2 from the surface of the heat shield 140, thereby ensuring that no part of the gas rail system 200, 200a contacts the heat shield 140 or another component in a way that affects the final positioning of the gas rail system 200, 200a, cooktop 120, etc.

As shown in FIGS. 5A and 5B, the clearance CA1, CA2 may be less than the clearance CB1, CB2 if, for example, the screws 226 draw the gas rail system 200, 200a upward against the underside of the surface of the cooktop 120 during assembly. In other embodiments, the clearance may stay the same, or the clearance can be reduced, for example, if the screws 226 have the affect of drawing the underside of the surface of the cooktop 120 down onto the gas rail system 200, 200a during assembly.

In other exemplary embodiments, the gas rail system 200, 200a can be supported in a spaced manner above the surface of the heat shield 140 and other components of the appliance 100 by other means. For example, the tabs 128, 129 can be formed on one or more of the rails 214, 215, 216, 219 for supporting the gas rail system 200, 200a in a spaced manner above the surface of the heat shield 140 and other components of the appliance 100. For example, the tabs 128 and/or 129 can be formed only on the first rail 215, the second rail 214, the center rail 216, or the spark module rail section 219, or on one or more of the first rail 215, the second rail 214, the center rail 216, and the spark module rail section 219. In other exemplary embodiments, the tabs 128 and/or 129 can be formed on other components of the gas rail system 200, 200a. The illustrated examples provide tabs 128 and/or 129 that engage support features 130, 132, 134, 136 of the sidewalls 122 to support the gas rail system 200, 200a in a spaced manner above the surface of the heat shield 140 and other components of the appliance 100. In other embodiments, the gas rail system 200, 200a can be supported by/from another component of the appliance 100 such that the gas rail system 200, 200a is arranged in a spaced manner above the surface of the heat shield 140 and other components of the appliance 100 without departing from the spirit and scope of the present invention. For example, the gas rail system 200, 200a can be supported by/from a support bracket for another component of the appliance, such as a support bracket for the control panel 110. In another example, the gas rail system 200, 200a can be supported by/from a surface of the flues 156 or related flue ducts, cooling air ducts, exhaust ducts, etc., or from another heat shield (not shown) for thermally isolating the gas rail system 200, 200a from these components.

With reference again to FIGS. 1-5D, an exemplary embodiment is directed to a home cooking appliance (e.g., 100) comprising a housing (e.g., 102), a gas cooktop on the housing (e.g., 102), the gas cooktop having a lower cooktop floor (e.g., 140) and an upper cooktop surface (e.g., 120), the gas cooktop having a cooktop burner (e.g., 108) on the upper cooktop surface (e.g., 120); and a gas rail system (e.g., 200, 200a) on the housing (e.g., 102), the gas rail system (e.g., 200, 200a) disposed between the lower cooktop floor (e.g., 140) and the upper cooktop surface (e.g., 120), the gas rail system (e.g., 200, 200a) supporting functional components (e.g., one or more of 201, 204, 206, 208, 210, 212, 220, 223, 224, 302, 304, 306, 308, 310, etc.) of the gas cooktop needed for gas leak testing the gas cooktop, wherein the gas rail system (e.g., 200, 200a) supports the functional components in a spaced manner (e.g., CA1, CA2, CB1, CB2) from the lower cooktop floor (e.g., 140).

With reference again to FIGS. 1-5D, another exemplary embodiment is directed to a home cooking appliance (e.g., 100) comprising a housing (e.g., 102), a gas cooktop on the housing (e.g., 102), the gas cooktop having a lower cooktop floor (e.g., 140) and an upper cooktop surface (e.g., 120), the gas cooktop having a cooktop burner (e.g., 108) on the upper cooktop surface (e.g., 120); and a gas rail system (e.g., 200, 200a) on the housing (e.g., 102) and disposed between the lower cooktop floor (e.g., 140) and the upper cooktop surface (e.g., 120), the gas rail system (e.g., 200, 200a) including means (e.g., one or more of 228 and 229, and one or more of 130, 132, 134, 136, etc.) for supporting functional components (e.g., one or more of 201, 204, 206, 208, 210, 212, 220, 223, 224, 302, 304, 306, 308, 310, etc.) of the gas cooktop needed for gas leak testing the gas cooktop, for supporting the functional components (e.g., one or more of 201, 204, 206, 208, 210, 212, 220, 223, 224, 302, 304, 306, 308, 310, etc.) in a spaced manner from the lower cooktop floor (e.g., 140), and for supporting the functional components (e.g., one or more of 201, 204, 206, 208, 210, 212, 220, 223, 224, 302, 304, 306, 308, 310, etc.) such that the functional components are capable of moving a predetermined distance in at least one of a vertical direction and a horizontal direction with respect to the housing (e.g., 102).

With reference again to FIGS. 1-5D, another exemplary embodiment is directed to a method of assembling a home cooking appliance (e.g., 100) having a gas cooktop, the method comprising providing a gas rail system (e.g., 200, 200a) having functional components of the gas cooktop in an assembled state needed for gas leak testing the gas cooktop, the gas rail system (e.g., 200, 200a) fixedly supporting the functional components (e.g., one or more of 201, 204, 206, 208, 210, 212, 220, 223, 224, 302, 304, 306, 308, 310, etc.) of the gas cooktop in the assembled state such that the gas rail system (e.g., 200, 200a) is transportable in the assembled state, performing the gas leak testing of the functional components (e.g., one or more of 201, 204, 206, 208, 210, 212, 220, 223, 224, 302, 304, 306, 308, 310, etc.) of the gas cooktop in the assembled state, providing a housing (e.g., 102) having a lower cooktop floor (e.g., 140), after performing the gas leak testing of the gas rail system (e.g., 200, 200a), mounting the gas rail system (e.g., 200, 200a) on the housing (e.g., 102) such that the gas rail system (e.g., 200, 200a) supports the functional components (e.g., one or more of 201, 204, 206, 208, 210, 212, 220, 223, 224, 302, 304, 306, 308, 310, etc.) of the gas cooktop in a spaced manner from the lower cooktop floor (e.g., 140), providing an upper cooktop surface (e.g., 120) and positioning the upper cooktop surface (e.g., 120) on the housing (e.g., 102) such that the gas rail system (e.g., 200, 200a) is disposed between the lower cooktop floor (e.g., 140) and the upper cooktop surface (e.g., 120), and fixing a final position of the gas rail system (e.g., 200, 200a) with respect to the upper cooktop surface (e.g., 120). The gas rail system (e.g., 200, 200a) is mounted on the housing in a manner that provides a range of movement of the gas rail system (e.g., 200, 200a) with respect to the housing (e.g., 102) until performing the fixing of the final position of the gas rail system (e.g., 200, 200a) with respect to the upper cooktop surface (e.g., 120).

The present invention has been described herein in terms of several preferred embodiments. However, modifications and additions to these embodiments will become apparent to those of ordinary skill in the art upon a reading of the foregoing description. It is intended that all such modifications and additions comprise a part of the present invention to the extent that they fall within the scope of the several claims appended hereto.

What is claimed is:

1. A home cooking appliance comprising:
a housing;
a gas cooktop on the housing, the gas cooktop having a lower cooktop floor and an upper cooktop surface, the gas cooktop having a cooktop burner on the upper cooktop surface; and
a gas rail system on the housing, the gas rail system disposed between the lower cooktop floor and the upper cooktop surface, the gas rail system supporting functional components of the gas cooktop needed for gas leak testing the gas cooktop,
wherein the gas rail system supports the functional components of the gas cooktop in a spaced manner from the lower cooktop floor.

2. The home cooking appliance of claim 1, wherein the gas rail system includes a support feature that supports the gas rail system on the housing in a manner that provides a range of movement of the gas rail system with respect to the housing.

3. The home cooking appliance of claim 1, wherein the functional components include mechanical components of at least one gas burner, the mechanical components including:
a gas valve;
a valve stem on the gas valve,
a burner orifice; and
a gas tube connecting the gas valve to the burner orifice.

4. The home cooking appliance of claim 3, wherein the functional components include electrical components of the at least one gas burner, the electrical components including:
a spark module;
a control device or valve switch;
an igniter;
a first wire connecting the spark module to the control device or valve switch; and
a second wire connecting the spark module to the igniter.

5. The home cooking appliance of claim 1, wherein the gas rail system includes a rail supporting the functional components.

6. The home cooking appliance of claim 5, wherein the rail includes a mounting section for supporting one or more of the functional components.

7. The home cooking appliance of claim 1, wherein the gas rail system includes means for supporting the gas rail system in the spaced manner from the lower cooktop floor.

8. The home cooking appliance of claim 1,
wherein the gas rail system includes a support feature,
wherein the housing includes a corresponding support feature, and
wherein the support feature of the gas rail system engages the corresponding support feature of the housing and supports the gas rail system in the spaced manner from the lower cooktop floor.

9. The home cooking appliance of claim 8, wherein the corresponding support feature is on a sidewall of the housing and the gas rail system extends substantially across a width of the housing.

10. The home cooking appliance of claim 8, wherein the corresponding support feature is on a front or rear wall of the housing and the gas rail system extends substantially across a depth of the housing.

11. The home cooking appliance of claim 8, wherein the gas rail system includes a rail supporting at least a first functional component of the functional components, and
wherein the rail includes the support feature that engages the corresponding support feature.

12. The home cooking appliance of claim 11, wherein the rail is supported by sidewalls on opposite sides of the housing and extends substantially across a width of the housing.

13. The home cooking appliance of claim 11, wherein the rail includes a linear rail extending in a direction from a first sidewall of the housing to a second sidewall of the housing.

14. The home cooking appliance of claim 11, wherein the rail includes an angled section.

15. The home cooking appliance of claim 11, wherein the rail includes a first section and a second section, and
wherein the first section is closer to the lower cooktop floor than the second section.

16. The home cooking appliance of claim 11, further comprising:
a second rail supporting at least a second functional component of the functional components.

17. The home cooking appliance of claim 16, further comprising:
a third rail supporting at least a third functional component of the functional components.

18. The home cooking appliance of claim 1, further comprising:
a fastener coupling a component of the gas rail system to an underside of the upper cooktop surface.

19. The home cooking appliance of claim 8, wherein the support feature of the gas rail system is capable of moving a predetermined distance in one or more directions with respect to the corresponding support feature of the housing.

20. The home cooking appliance of claim 19, wherein the support feature of the gas rail system is capable of moving a predetermined distance in a vertical direction with respect to the corresponding support feature of the housing.

21. The home cooking appliance of claim 19, wherein the support feature of the gas rail system is capable of moving a predetermined distance in a horizontal direction with respect to the corresponding support feature of the housing.

22. The home cooking appliance of claim 1, wherein the functional components include mechanical components of a plurality of gas burners, the mechanical components including:
a gas valve for each of the plurality of gas burners;
a valve stem on the gas valve for each of the plurality of gas burners,
a burner orifice for each of the plurality of gas burners;
a gas tube connecting the gas valve to the burner orifice for each of the plurality of gas burners; and
a gas manifold pipe for supplying gas to each gas valve of the plurality of gas burners.

23. The home cooking appliance of claim 22, wherein the functional components include electrical components of the plurality of gas burners, the electrical components including:
a spark module;
a control device or valve switch for each of the plurality of gas burners;
an igniter for each of the plurality of gas burners;
a first wire for each of the plurality of gas burners, the first wire connecting the spark module to the control device or valve switch for each of the plurality of gas burners; and
a second wire for each of the plurality of gas burners, the second wire connecting the spark module to the igniter for each of the plurality of gas burners.

24. A home cooking appliance comprising:
a housing;
a gas cooktop on the housing, the gas cooktop having a lower cooktop floor and an upper cooktop surface, the gas cooktop having a cooktop burner on the upper cooktop surface,
a gas rail system on the housing and disposed between the lower cooktop floor and the upper cooktop surface,
the gas rail system including means for supporting functional components of the gas cooktop needed for gas leak testing the gas cooktop, for supporting the functional components in a spaced manner from the lower cooktop floor, and for supporting the functional components such that the functional components are capable of moving a predetermined distance in at least one of a vertical direction and a horizontal direction with respect to the housing.

25. A method of assembling a home cooking appliance having a gas cooktop, the method comprising:
providing a gas rail system having functional components of the gas cooktop in an assembled state needed for gas leak testing the gas cooktop, the gas rail system fixedly supporting the functional components of the gas cooktop in the assembled state such that the gas rail system is transportable in the assembled state;
performing the gas leak testing of the functional components of the gas cooktop in the assembled state;
providing a housing having a lower cooktop floor;
after performing the gas leak testing of the gas rail system, mounting the gas rail system on the housing such that the gas rail system supports the functional components of the gas cooktop in a spaced manner from the lower cooktop floor;
providing an upper cooktop surface and positioning the upper cooktop surface on the housing such that the gas rail system is disposed between the lower cooktop floor and the upper cooktop surface; and
fixing a final position of the gas rail system with respect to the upper cooktop surface.

26. The method of claim 25, wherein the gas rail system is mounted on the housing in a manner that provides a range of movement of the gas rail system with respect to the housing until performing the fixing of the final position of the gas rail system with respect to the upper cooktop surface.

27. The method of claim 25, wherein the functional components include mechanical components of at least one gas burner, the mechanical components including:
a gas valve;
a valve stem on the gas valve,
a burner orifice; and
a gas tube connecting the gas valve to the burner orifice.

28. The method of claim 27, wherein the functional components include electrical components of the at least one gas burner, the electrical components including:
a spark module;
a control device or valve switch;
an igniter;
a first wire connecting the spark module to the control device or valve switch; and
a second wire connecting the spark module to the igniter.
